(19) United States
(12) Patent Application Publication
(10) Pub. No.: US 2014/0097661 A1
(43) Pub. Date: Apr. 10, 2014

(54) AIRCRAFT SEAT

(71) Applicant: Roland LOHER, Wallersdorf-Haidlfing (DE)

(72) Inventor: Roland LOHER, Wallersdorf-Haidlfing (DE)

(21) Appl. No.: 14/048,625

(22) Filed: Oct. 8, 2013

(30) Foreign Application Priority Data
Oct. 9, 2012 (DE) 10 2012 109 597.3

(51) Int. Cl. B64D 11/06

(52) U.S. Cl. CPC B64D 11/06
USPC 297/452.41

(57) ABSTRACT

An aircraft seat comprising a seat element which comprises a seat cushion having a flexible material and forming the seat surface, characterized in that in the area of the left or right half of the seat cushion (2) or in the area of both halves of the seat cushion, one independent of the other, the seat height can be varied by introducing a medium into the seat element and/or by draining a medium from the seat element.

The present invention relates to an aircraft seat comprising a seat element which forms the seat surface and has at least one flexible material.

Aircraft seats of this kind are known from the state of the art. The seat element generally comprises a seat cushion filled with foam, and a carrier element, such as a hard plastic seat shell, to which the seat cushion is fixed with its lower side. The top side of the seat cushion forms the seat surface. The seat cushion further usually comprises a cover of leather or fabric.

When a passenger aircraft has reached its cruising altitude and is in level flight, the passenger aircraft is inclined by about 3°, i.e. the longitudinal axis of the passenger aircraft and the horizontal form an angle a of about 3°. In conventional aircraft, such an inclination of 3° does not pose a problem since usually all aircraft seats are positioned in the travel direction, i.e. the passengers' line of vision corresponds to the travel direction and the passengers are merely sitting in a position slightly inclined backwards. Such a sitting position is not uncomfortable.

However, this does not apply to aircraft in which the passengers also sit diagonally to the travel direction. For example, this may be the case if the aircraft is equipped with large conference tables whose longitudinal axis runs parallel to the longitudinal axis of the aircraft and passengers sit on the long sides of the table. Such table and seat arrangements can be found in so called VIP aircraft, for example. In the extreme case, a passenger is sitting in this kind of aircraft in such a position that the line of vision and the travel direction form an angle of roughly 90°. In such a sitting position, the passenger is subjected to a sideways inclination of about 3°, which is extremely uncomfortable especially on longer flights.

It is the objective of the present invention to provide an aircraft seat that overcomes the above-mentioned disadvantages of the aircraft seats from the state of the art.

This objective is attained by an aircraft seat of the kind mentioned in the beginning, which is characterized in that in the area of the left or right half of the seat cushion or in the area of both halves of the seat cushion, one independent of the other, the seat height can be varied by introducing and/or draining a medium into or from the seat element.

The left half of the seat cushion is understood to be the area of the seat cushion on which the left buttock is usually positioned when sitting. The right half of the seat cushion is understood to be the area of the seat cushion on which the right buttock is usually positioned when sitting.

In aircraft seats that are rigidly pre-mounted in a sideways position, it is sufficient if a height adjustment is possible only in the area of one seat surface half. Generally, however, it is the case that aircraft seats can be positioned flexibly and it is not determined whether the passenger sits looking at the right or left row of windows. In this case, it is particularly advantageous if both seat surface halves are height-adjustable.

The medium can be a liquid or a gel-like compound, for example. Preferably, however, the medium is a gaseous medium, particularly preferably air. Using air has different advantages, such as a simple composition of the overall structure, low cost and uncomplicated handling.

In the aircraft seat according to the invention, an asymmetric introduction or discharge of medium in certain zones of the seat element is possible. In this way it is achieved that different pressures can be generated in different zones of the seat element, in particular of the seat cushion. By means of the different pressures, a varied compression of the flexible material in the seat cushion is generally achieved. This, in turn, leads to different seat heights in the different zones, in particular in the left and right half of the seat cushion (or of the seat surface, respectively), by raising and lowering the seat surface zones in varying degrees. In this way it is achieved that even in flight the entire seat surface is oriented substantially horizontally after the inclination compensation so that the passenger does not have to sit inclined to one side when sitting in a sideways position (line of vision at a 90° angle to the travel direction, for example).

In a preferred embodiment of the aircraft seat according to the invention, at least one, preferably two inclination compensation cushions, which can be filled with or drained of medium, in particular air, are arranged inside or under the seat cushion (e.g. between carrier element and seat cushion), which are preferably positioned in the area of the left or right half of the seat cushion. By means of such inclination compensation cushions that are integrated into the seat element, a particularly effective adjustment of the seat heights in the respective zones of the seat cushion is possible. Generally, said inclination compensation cushions comprise a flexible material, preferably foam, wherein the flexible material is preferably enclosed by an air-tight material, which is also formed flexible (e.g. flexible plastic, rubber etc.).

Preferably, the inclination compensation cushion(s) comprise(s) a pneumatic connection for evacuating and/or introducing air. Said pneumatic connection can be connected to a vacuum pump, by means of which air can be sucked out of the respective inclination compensation cushion.

Usually, the flexible material of the seat cushion is plastic foam (foam material). Material of this kind is particularly suited for increasing the seat height by raising the seat surface and for lowering it again.

The introduction and evacuation of media can be effected manually (e.g. via a keyboard). In a preferred configuration of the aircraft seat according to the invention, the evacuation and/or introduction of media is controlled automatically, wherein preferably sensors are arranged in the seat, which recognize the position, in particular the rotational position of the seat. If in flight the sensors recognize a specific position of the seat in which the passenger is not sitting in the travel direction (or against the travel direction), but rather has a sideways sitting position, the respective valves responsible for seat compensation are activated to evacuate or introduce medium (see also description of the figures). In another preferred embodiment, the sensors also recognize if the aircraft is no longer in level flight, but if it is descending or has even reached the ground again, for example. In that case, the respective valves are again activated to evacuate or introduce medium.

The present invention further relates to a method for compensating a tilted sitting position caused by the angle of attack of an aircraft in flight in case of a sideways seat position, wherein, by introducing and/or draining a medium into or from a seat element of the aircraft seat, a different seat height is caused in a left area of the seat surface of the aircraft seat than in a right area. In this manner, it is again achieved that a different (adjusted) seat height is adjusted in a left area of the seat cushion of the aircraft seat than in the right area (in this context, seat height is understood to be the distance between the seat surface and the floor of the aircraft). This ultimately leads to the entire seat surface being put into a substantially horizontal position. A sideways seat position is understood to be a seat position in which the passenger is not sitting with his/her line of vision in the travel direction, but for example with their line of vision towards the left or right longitudinal side of the aircraft.

In a preferred method variation of the method according to the invention, one inclination compensation cushion is arranged in a left area of the seat surface and/or in a right area of the seat surface, respectively, wherein a medium, in particular air, is sucked out of the inclination compensation cushion that is positioned in the travel direction. It is also possible to introduce medium into the other inclination compensation cushion in order to compensate the inclination.

Advantageously, the compensation of the angle of attack takes place automatically in that the seat position is detected by sensors and, depending on the seat position, either the left or the right seat half, or the left or right inclination compensation cushion, is activated, respectively. In this method variation, in each case, one valve is activated, in particular, that is connected to the left or right inclination compensation cushion and can evacuate or introduce medium, in particular air, from or into the respective compensation inclination cushion.

Other features of the subject matter of the invention arise from the following description of preferred exemplary embodiments of the invention in connection with the drawing and the dependent claims. In this context, the individual features can be realized individually or in combination with one another.

The drawings show:

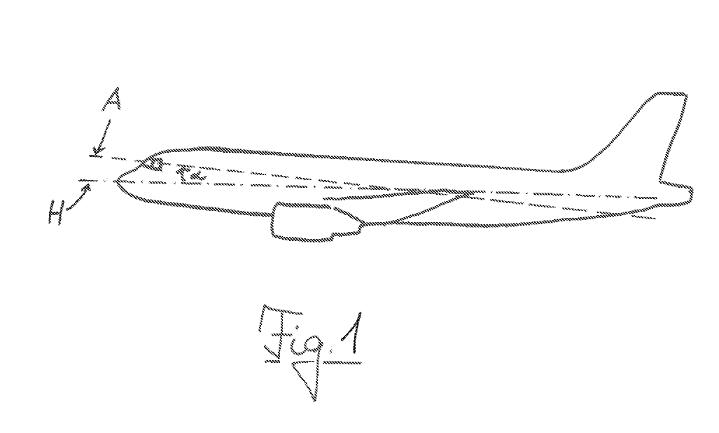

FIG. 1: a passenger aircraft in level flight;

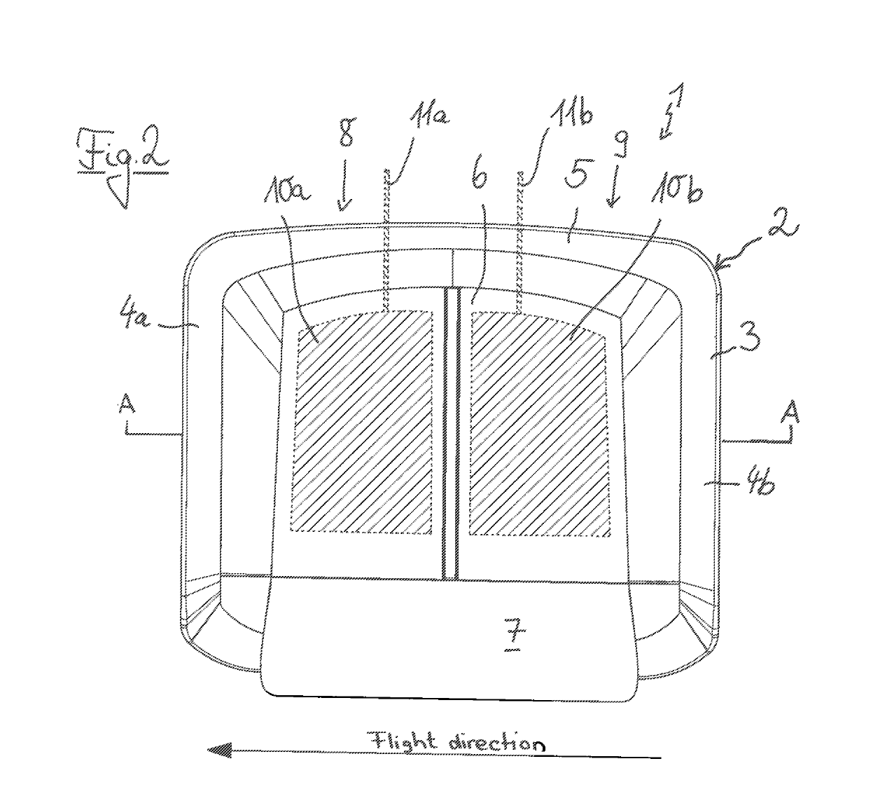

FIG. 2: a top view of a seat element of an aircraft seat according to the invention;

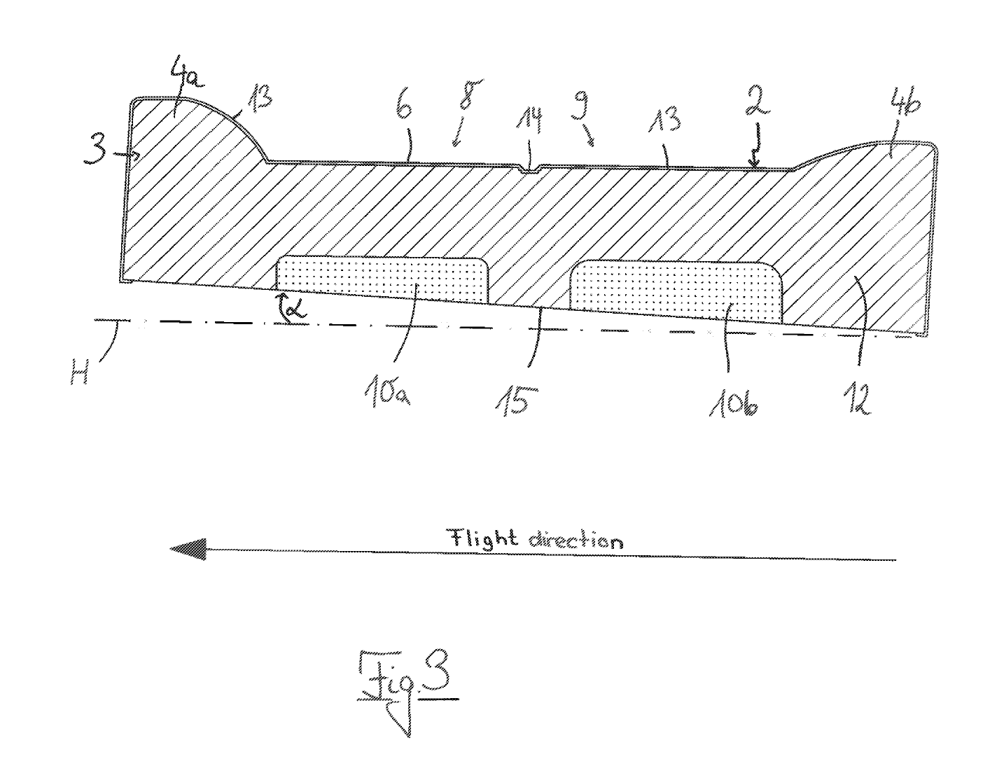

FIG. 3: a section along the line A-A of FIG. 1;

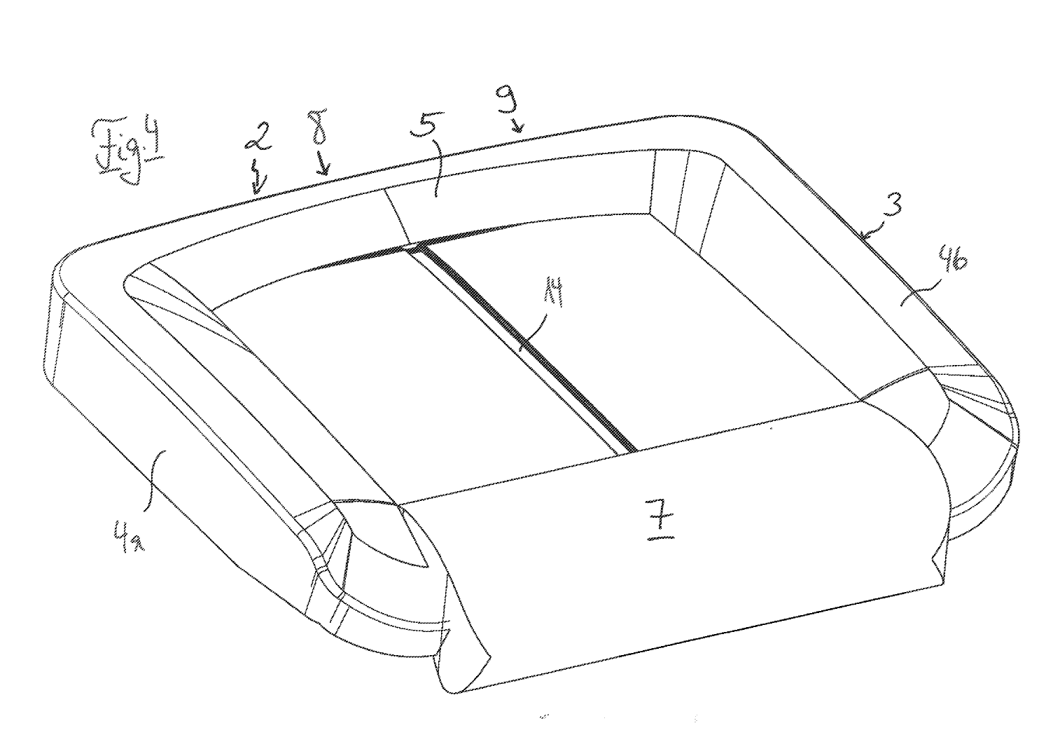

FIG. 4: a perspective illustration of the seat cushion of FIG. 2;

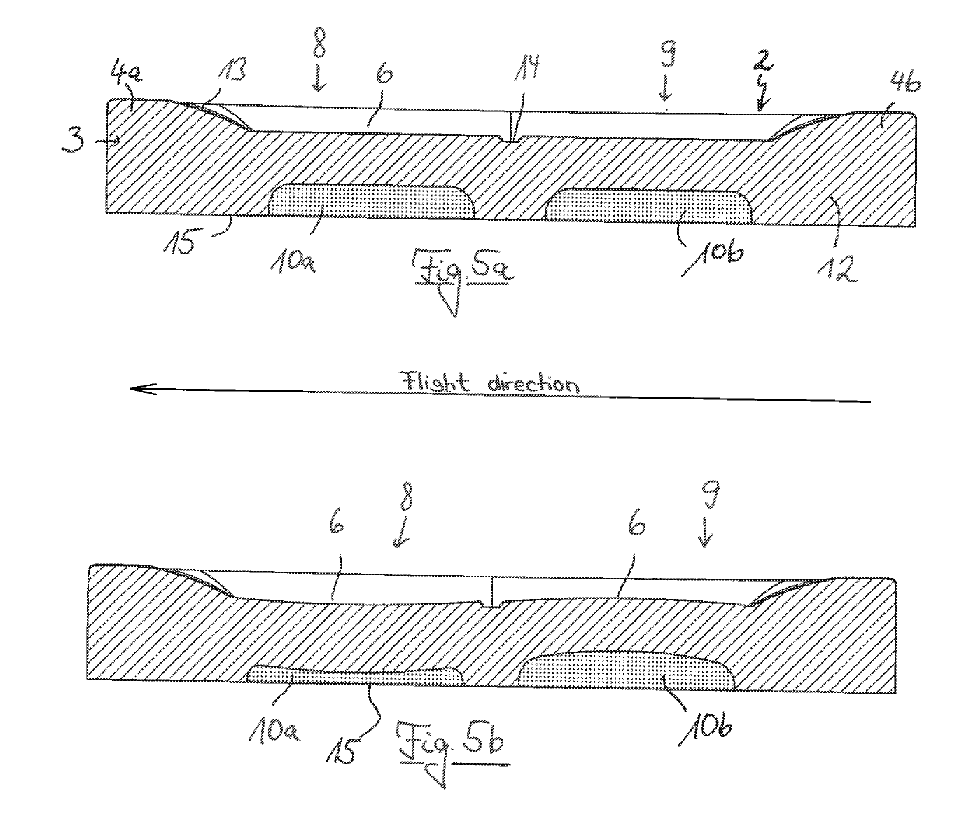

FIG. 5a, 5b: a section through another seat cushion of an aircraft seat according to the invention.

FIG. 1 shows a passenger aircraft in level flight, which due to its aerodynamic construction is inclined by an angle a of about 3°. In FIG. 1, the horizontal H and the longitudinal axis A of the aircraft hull are indicated, which together form the angle α. Passengers who for example are sitting looking out the window (diagonal seat position), in customary aircraft seats, would be sitting in a tilted sitting position in their aircraft seats, which is not comfortable.

FIG. 2 shows a top view of an aircraft seat 1 according to the invention, in which, however, the backrest and the armrests were omitted for the purpose of clarity and only the seat cushion 2 of the seat element is visible. Apart from the seat cushion 2, the seat element also comprises a carrier shell made of plastic (not illustrated), which carries the seat cushion 2. The seat cushion 2 presents a bulge-shaped, non-closed frame 3, which comprises two lateral portions 4a and 4b and a rear side portion 5. The frame 3 of the seat cushion 2 surrounds the seat surface 6 of the seat cushion 2 and is higher than the latter. In the front area of the seat cushion, the seat surface 6 ends in a frontal edge zoning 7, which curves downward and which allows for comfortable sitting because the rounded form of the portion 7 adapts optimally to the anatomy of a passenger, in particular to an area of transition from the thigh to the lower leg.

In the area of the right half 8 (from a sitting passenger's perspective) and in the area of the left half 9 of the seat cushion 2, one inclination compensation cushion 10a and 10b is integrated into the seat cushion 2, respectively. The two inclination compensation cushions 10a and 10b each comprise a pneumatic connection 11a and 11b, which protrude out of the seat cushion 2 towards the rear and there are connected to a vacuum pump (not illustrated). With the aid of the vacuum pump, the two compensation cushions 10a and 10b can be evacuated or inflated independently of each other.

FIG. 3 shows a longitudinal section through the seat cushion 2 of FIG. 2 (along the line A-A). The seat cushion 2 comprises foam 12 and has a leather cover 13. In this illustration, the lateral areas 4a and 4b of the bulge-shaped frame 3 are visible, too, which surround the seat surface 6 and are higher than the latter, wherein the frame 3 ends directly in the seat surface 6. A middle seam 14 separates the seat surface 6 into a right half 8 and a left half 9. The bottom 15 of the seat cushion 2 is firmly connected to a carrier shell (not illustrated), which is also a part of the seat element.

In FIG. 3, the situation during a level flight is illustrated. The bottom 15 of the seat cushion 2 is inclined by about 3°, which corresponds to the angle of attack in flight. The inclination compensation cushions 10a and 10b are integrated into the seat cushion 2 in the lower area thereof. Both inclination compensation cushions are filled with foam and air.

In the situation illustrated in FIG. 3, air has been sucked out of the compensation cushion 10a positioned in the travel direction (in the travel direction means positioned closer to the cockpit of the aircraft). The compensation cushion 10b is not evacuated. By evacuating the compensation cushion 10a, it has been achieved that the seat surface 6 has become a little lower in the area of the right half 8 of the seat cushion 2, which has caused the distance between the seat surface 6 and the bottom 15 in the right half 8 of the seat cushion 2 to decrease. In this way, it has been achieved that the entire seat surface 6 has been put into an overall approximately horizontal position. Thus, in turn, it has been achieved that the passenger sitting on the seat cushion sits in a straight and upright position while of course the angle of attack of 3° is still present.

FIG. 4 shows a perspective illustration of the seat cushion 2.

FIGS. 5a and 5b show a longitudinal section through a seat cushion of another embodiment of an aircraft seat according to the invention, which is very similar to the embodiment of FIG. 3. For that reason, the same reference signs were used for the same elements.

FIG. 5a shows the seat cushion 2 while the aircraft carrying the respective aircraft seat is on the ground. This means that the seat cushion 2 is in a “neutral position”, i.e. the two compensation cushions 10a and 10b have the same height. In analogy to FIG. 3, the seat cushion 2 has a leather cover 13. Here, too, the lateral areas 4a and 4b of the bulge-shaped frame 3 are visible, which surround the seat surface 6 and are higher than the latter, wherein the frame 3 ends directly in the seat surface 6. A middle seam 14 separates the seat surface 6 into a right half 8 and a left half 9. The bottom 15 of the seat cushion 2 is firmly connected to a carrier frame (not illustrated), which is also part of the seat element. The inclination compensation cushions 10a and 10b are integrated into the seat cushion 2 into the lower area thereof. Both inclination compensation cushions 10a and 10b are filled with foam and air.

FIG. 5b shows the situation in the seat cushion during level flight of the aircraft. In the situation illustrated here, air has been sucked out of the compensation cushion 10a positioned in the travel direction, whereas air has been pumped into the compensation cushion 10b. By evacuating the compensation cushion 10a, it has been achieved that the seat surface 6 has become a little lower in the area of the right half 8 of the seat cushion 2, which means that the distance between the seat surface 6 and the bottom 15 in the right half 8 of the seat cushion 2 has decreased. By inflating the seat cushion 10b, it has been achieved that the seat surface 6 in the area of the left half 9 of the seat cushion 2 has become a little more elevated and has taken on a slight curving to the outside. In this manner, it has again been achieved that the person sitting on the seat sits in a straight and upright position when the seat is positioned sideways although the angle of attack of 3° is present.

The difference to the embodiment of FIG. 3 lies in particular in the fact that, here, both inclination compensation cushions experience a change (evacuation or inflation). Owing to the somewhat more flexible foam in the embodiment shown in FIG. 5, as compared to the embodiment of FIG. 3, here, curving and indentations of the seat surface occur. The achieved effect is the same in both embodiments. The angle of attack arising in flight is compensated in both embodiments.

It is to be appreciated that the aircraft seat, in particular the area of the seat cushion and of the inclination compensation cushions, can be configured differently than shown in the Figures. For instance, the seat cushion can also be composed of two parts, which are merely connected to each other by the seat cover. For instance, it is conceivable that the seat cushion is constructed of two originally separate foam parts, which are connected to each other by the seat cover, wherein the middle seam covers the contact surfaces of the two parts, for example.

Further, it is conceivable that the inclination compensation cushions are arranged in the upper area of the seat cushion. Further, it is conceivable that the inclination compensation cushions fill the seat cushion across its entire width and are in contact with the cover in the upper area. It is also conceivable that no separate compensation cushions are integrated into the seat cushion, but that the seat cushion itself comprises cavities into/from which medium can be introduced and drained.

Further, it is conceivable that when draining an area or a compensation cushion, the inclination of the seat surface without a load does not yet undergo an inclination or only an insubstantial one and only if a load is exerted on the seat surface by a sitting person, does the drained region sink deeper than the region not drained, and thus an inclination compensation takes place. Whether an inclination is compensated already in the unloaded state also depends on the material within the seat cushion.

Even quicker inclination compensation is achieved if—as shown in FIG. 3—the inclination cushion 10a is evacuated and at the same time medium, in particular air, is introduced into the inclination cushion 10b.

Further, it is conceivable that inflatable structures, such as inclination compensation cushions, are positioned under the seat cushion and when inflated they press against the lower side (bottom) of the seat cushion, for example, thereby pushing upwards the flexible material in the seat cushion, which, in turn, causes a corresponding raising of the seat surface.

1. An aircraft seat comprising a seat element, which comprises a seat cushion having a flexible material and forming the seat surface,
wherein in the area of the left or right half of the seat cushion or in the area of both halves of the seat cushion, one independent of the other, the seat height can be varied by introducing a medium into the seat element and/or by draining a medium from the seat element.

2. The aircraft seat according to claim 1,
wherein
inside or under the seat cushion, at least one inclination compensation cushions are arranged, which can be filled with a medium, and/or evacuated and which are preferably positioned in the area of the left or right half of the seat cushion.

3. The aircraft seat according to claim 2,
wherein
the inclination compensation cushion(s) each comprise a pneumatic connection for evacuating and/or introducing air.

4. The aircraft seat according to claim 1,
wherein
the flexible material of the seat cushion is foam.

5. The aircraft seat according to claim 2,
wherein
the inclination compensation cushions contain flexible material.

6. The aircraft seat according to claim 1,
wherein
the evacuation and/or introduction of medium is controlled automatically by a control device, wherein sensors are arranged in the seat, which recognize the position, of the seat.

7. The aircraft seat according to claim 6,
wherein
during a flight, in a position of the seat in which the line of vision of a person sitting in the seat forms a substantially right angle with the travel direction, the pressures in the seat cushion are automatically adjusted such that the tilted position of the seat surface is compensated.

8. A method for compensating a tilted seat position caused by the angle of attack of an aircraft during a flight in case of a sideways seat position, wherein by introducing and/or draining a medium into or from a seat element of the aircraft seat, a different seat height is produced in a left area of the seat surface of the aircraft seat than in a right area.

9. The method according to claim 8,
wherein
in a left area of the seat surface and/or in a right area of the seat surface, one inclination compensation cushion is arranged, respectively, wherein a medium is evacuated from the inclination compensation cushion that is located forward in the travel direction and/or wherein a medium is pumped into the inclination compensation cushion that is not located in the flight direction.

10. The method according to claim 8,
wherein
compensation takes place automatically in that the seat position is detected by sensors and, depending on the seat position, either the left seat half or the right seat half or the left inclination compensation cushion or the right inclination compensation cushion is activated, respectively.
